(19) United States
(12) Patent Application Publication
(10) Pub. No.: US 2012/0242190 A1
(43) Pub. Date: Sep. 27, 2012

(54) SAW SENSOR

(75) Inventors: Du-Hwan Choi, Suwon-city (KR); Tae-Ho Kim, Yongin-city (KR); Jae-Woo Seo, Bucheon-city (KR); Seung-Man Lim, Seoul (KR); Do-Hyung Kim, Seongnam-city (KR); Byeong-Kyoo Shon, Anyang-city (KR)

(73) Assignee: MDT CO.,LTD., Seongnam, Gyeonggi-do (KR)

(21) Appl. No.: 12/672,686

(22) PCT Filed: Aug. 8, 2008
(86) PCT No.: PCT/KR08/04646

§ 371 Date: Sep. 29, 2010

(30) Foreign Application Priority Data
Aug. 9, 2007 (KR) 10-2007-0080322

(51) Int. Cl. G01L 1/16

(52) U.S. Cl. 310/313 D

(57) ABSTRACT

Provided is a surface acoustic wave (SAW) sensor sensing pressure, temperature, etc., by using a SAW. The SAW sensor includes: a substrate having one of its surfaces formed with a cavity having a predetermined depth; a piezoelectric plate which has piezoelectricity, so as to make a SAW, and which is adhered to the surface in which the cavity is formed, so as to cover the cavity of the substrate; a pressure resonator which is installed to a portion of the piezoelectric plate that corresponds to the cavity groove, and which generates a SAW due to a radio frequency (RF) signal applied thereto; and a reference resonator which is installed to the piezoelectric plate to be outside the portion corresponding to the cavity and be parallel to the pressure resonator, and which generates a SAW due to the RF signal applied thereto.

### TECHNICAL FIELD

The present invention relates to a surface acoustic wave (SAW) sensor, and more particularly, to a SAW sensor which senses a change of pressure, temperature, etc., by using a SAW resonator that generates a SAW due to a radio frequency (RF) signal applied to the SAW resonator.

### BACKGROUND ART

Generally, a resonator, which generates a surface acoustic wave (SAW), may be constituted by disposing a plurality of inter-digital transducer (IDT) metal electrodes on a piezoelectric plate formed of material, such as LiNbO₃, having piezoelectricity at regular intervals.

FIG. 1 is a cross-sectional view of a conventional SAW sensor which senses pressure by using a SAW resonator.

Three SAW resonators 4, 5, and 6 are disposed in parallel on a piezoelectric plate 3. The piezoelectric plate 3 is installed in a case 2 so that both ends of the piezoelectric plate 3 are supported by the case 2. A diaphragm 1, to which an external pressure can be directly applied, is disposed above the piezoelectric plate 3. As illustrated in FIG. 1, the diaphragm 1 contacts the piezoelectric plate 3 between the both ends of the piezoelectric plate 3 that are supported by the case 2 so that the external pressure is transferred to the piezoelectric plate 3 through the diaphragm 1.

When the external pressure is transferred to the piezoelectric plate 3 through the diaphragm 1, the piezoelectric plate 3 is bent. Due to the deformation of the piezoelectric plate 3, SAW characteristics of the SAW resonators 4, 5, and 6 are changed. Thus, a resonant frequency of each of the SAW resonators 4, 5, and 6 is changed. Since the amount of deformation of the piezoelectric plate 3 is changed according to the position in which each of the SAW resonators 4, 5, and 6 is disposed, the amount of change of the resonant frequency of each of the SAW resonators 4, 5, and 6 is changed.

Accordingly, the amount of change of an external pressure can be calculated by analyzing the amount of change of the resonant frequency of each of the SAW resonators 4, 5, and 6, which vibrate due to an RF signal applied to each of the resonators 4, 5, and 6, due to the pressure.

However, in the conventional SAW sensor illustrated in FIG. 1, it is difficult to calculate the amount of change of pressure by sensing the amount of change of the respective resonant frequencies of the resonators 4, 5, and 6, since the respective resonant frequencies of the three SAW resonators 4, 5, and 6 all change according to the change in pressure, thereby not so accurately measuring the amount of change in pressure. In other words, the SAW resonators 4, 5, and 6 are not ones that do not change resonant frequencies even though pressure is changed.

Furthermore, in the conventional SAW sensor, an external pressure is not directly applied to the piezoelectric plate 3 but is instead indirectly applied thereto through the diaphragm 1. Also, a very fine and delicate manufacturing technology is needed to manufacture the conventional SAW sensor that has sufficient sensitivity and accuracy to sense pressure, thereby increasing manufacturing costs of the conventional SAW sensor.

### DESCRIPTION OF THE DRAWINGS

FIG. 1 is a cross-sectional view of a conventional surface acoustic wave (SAW) sensor;

FIG. 2 is an exploded perspective view of a SAW sensor according to an embodiment of the present invention;

FIGS. 3 and 4 are cross-sectional views taken along line of the SAW sensor illustrated in FIG. 2; and

FIG. 5 is an exploded perspective view of a SAW sensor according to another embodiment of the present invention.

<Explanation of Reference Numerals Designating
the Major Elements of the Drawings>

| | |
|---|---|
| 100, 200: SAW sensor | 110, 210: substrate |
| 120, 220: piezoelectric plate | 111, 211: cavity |
| 130, 230: pressure resonator | 140, 240: reference resonator |
| 150, 250: temperature resonator | 121, 221: membrane |
| 112: reference resonator groove | 113: ressure resonator groove |
| 212: reference resonator hole | 213: pressure resonator hole |

### DETAILED DESCRIPTION OF THE INVENTION

### Technical Problem

The present invention provides a surface acoustic wave (SAW) sensor having an improved structure in which an external pressure is directly applied to a piezoelectric plate so that he sensitivity and accuracy for sensing pressure can be improved and in which an additional resonator, having a resonant frequency that is not changed even though an external pressure is changed, is disposed so that a performance in sensing pressure can be improved.

### Advantageous Effects

In the SAW sensor according to the present invention, pressure is directly applied to a piezoelectric plate in which a plurality of resonators are installed, so that the amount of change of a resonant frequency of each of the resonators according to pressure has linearity and thus the accuracy and sensitivity for sensing pressure can be improved.

Furthermore, in the SAW sensor according to the present invention, an additional resonator, having a resonant frequency that is not changed even though an external pressure is changed, is disposed so that pressure can be more accurately and easily sensed.

Furthermore, the resonant frequency of each of the resonators is changed according to the thickness, size, and material of a piezoelectric plate in which the resonator are installed. In the case of the SAW sensor according to the present invention, both a reference resonator and a pressure resonator are installed on one piezoelectric plate so that a resonant frequency error of the pressure resonator can be very easily compensated for based on the reference resonator and high manufacturing yield can be achieved.

### Best Mode

According to an aspect of the present invention, there is provided a surface acoustic wave (SAW) sensor sensing pressure, temperature, etc., by using a SAW, the SAW sensor including: a substrate having one of its surfaces formed with a cavity having a predetermined depth; a piezoelectric plate which has piezoelectricity, so as to make a SAW, and which is adhered to the surface in which the cavity is formed, so as to cover the cavity of the substrate; a pressure resonator which is installed to a portion of the piezoelectric plate that corresponds to the cavity groove, and which generates a SAW due to a radio frequency (RF) signal applied thereto; and a reference resonator which is installed to the piezoelectric plate to be outside the portion corresponding to the cavity and be parallel to the pressure resonator, and which generates a SAW due to the RF signal applied thereto.

The reference resonator and the pressure resonator may be installed on the surface of the piezoelectric plate which faces the substrate, and a reference resonator groove in which the reference resonator is accommodated may be formed in the substrate.

The reference resonator and the pressure resonator may be installed on the surface of the piezoelectric plate which faces the substrate, and a portion of the substrate corresponding to the reference resonator may be perforated.

The reference resonator and the pressure resonator each may include an oscillation inter-digital transducer (IDT) which generates a SAW due to an externally applied RF signal, and a plurality of reflective IDTs, one or more of which is disposed respectively at sides of the oscillation IDT and which reflect the SAW generated in the oscillation IDT.

The SAW sensor may further include a temperature resonator which is installed on the piezoelectric plate, is disposed inclined with respect to the reference resonator, and which generates a SAW due to an RF signal applied thereto.

The reference resonator, the pressure resonator, and the temperature resonator may be installed on a surface of the piezoelectric plate which faces the substrate, and a reference resonator groove, in which the reference resonator is accommodated, and a temperature resonator groove, in which the temperature resonator is accommodated, may be formed in the substrate.

The reference resonator, the pressure resonator, and the temperature resonator may be installed on the surface of the piezoelectric plate which faces the substrate, and each of portions of the substrate corresponding to the reference resonator and the temperature resonator may be perforated.

The reference resonator, the pressure resonator, and the temperature resonator each may include an oscillation inter-digital transducer (IDT) which generates a SAW due to an externally applied RF signal, and a plurality of reflective IDTs, one or more of which is disposed respectively at sides of the oscillation IDT and which reflect the SAW generated in the oscillation IDT.

### Mode of the Invention

Hereinafter, exemplary embodiments of the present invention will be described in detail with reference to the attached drawings.

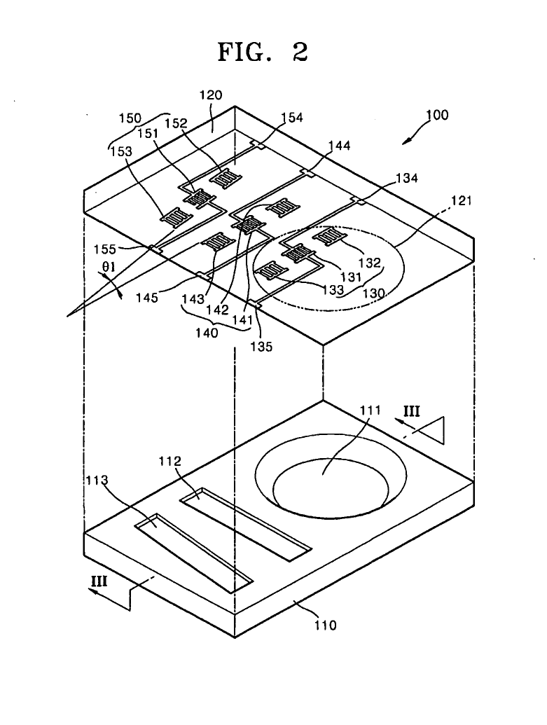

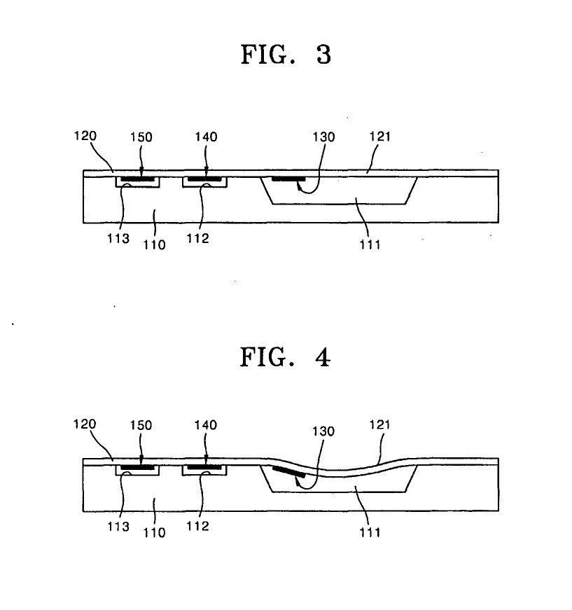

FIG. 2 is an exploded perspective view of a surface acoustic wave (SAW) sensor 100, according to an embodiment of the present invention, and FIG. 3 is a cross-sectional view taken along line of the SAW sensor 100 illustrated in FIG. 2.

Referring to FIGS. 2 and 3, the SAW sensor 100, according to the current embodiment of the present invention, comprises a substrate 110, a piezoelectric plate 120, a reference resonator 140, a pressure resonator 130, and a temperature resonator 150.

A cavity 111 having a predetermined depth is formed in the substrate 110. The substrate 110 may be formed of various materials. In the current embodiment, the substrate 110 is formed of silicon (Si), which facilitates processing, such as etching, etc., to be performed by using a semiconductor process or a micro electro mechanical system (MEMS) process.

The piezoelectric plate 120 is formed of material having piezoelectricity. LiNbO₃, etc., may be used as material for the piezoelectric plate 120. In the current embodiment, the piezoelectric plate 120 is formed of quartz.

All of the reference resonator 140, the pressure resonator 130, and the temperature resonator 150 are SAW resonators that generate a SAW by using a radio frequency (RF) signal applied thereto. The reference resonator 140, the pressure resonator 130, and the temperature resonator 150 comprise an oscillation inter-digital transducer (IDT) 131, 141 and 151, and two reflective IDTs 132 and 133, 142 and 143, and 152 and 153, respectively. Each of the reference resonator 140, the pressure resonator 130, and the temperature resonator 150 is formed by printing a metal IDT electrode on the piezoelectric plate 120. The oscillation IDT 131, 141 or 151 generates a SAW due to an externally applied RF signal. The two reflective IDTs 132 and 133, 142 and 143, and 152 and 153 are disposed at sides of the oscillation IDT 131, 141 and 151, respectively, along a propagation direction of the SAW that is generated in the oscillation IDT 131, 141 and 151.

The pressure resonator 130 is disposed parallel to the reference resonator 140; however, the temperature resonator 150 is disposed not parallel to the reference resonator 140. An angle θ1 formed between the reference resonator 140 and the temperature resonator 150 may be determined according to properties of matter of the piezoelectric plate 120.

The piezoelectric plate 120, on which the reference resonator 140, the pressure resonator 130, and the temperature resonator 150 are printed, is adhered to the substrate 110. In this case, a bottom surface of the piezoelectric plate 120, on which the reference resonator 140, the pressure resonator 130, and the temperature resonator 150 are printed, faces the substrate 110, so that the piezoelectric plate 126 and the substrate 110 can be adhered to each other. As such, the cavity 111 of the substrate 110 is covered by the piezoelectric plate 120. A portion of the piezoelectric plate 120, which corresponds to the cavity 111, is referred to as a membrane 121.

When the reference resonator 140, the pressure resonator 130, and the temperature resonator 150 are disposed on the piezoelectric plate 120, the pressure resonator 130 is disposed in a portion to correspond to the membrane 121, i.e., in a portion in which the piezoelectric plate 120 will face the cavity 111 of the substrate 110. The reference resonator 140 and the temperature resonator 150 are disposed outside the membrane 121.

When the substrate 110 and the piezoelectric plate 120 are adhered to each other, the pressure resonator 130 is accommodated in the cavity 111, and the pressure resonator 130 does not contact the substrate 110. And a space between the substrate 110 and the piezoelectric plate 120 is formed in the membrane 121.

In addition, a reference resonator groove 112 and a temperature resonator groove 113 are formed in the substrate 110 so that the reference resonator 140 and the temperature resonator 150 do not contact the substrate 110. Thus, when the piezoelectric plate 120 and the substrate 110 are adhered to each other, the reference resonator 140 and the temperature resonator 150 are accommodated in the reference resonator groove 112 and the temperature resonator 113, respectively.

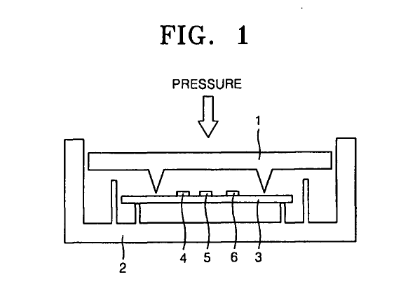

The function of the SAW sensor 100 of FIG. 1 will now be described.

When an RF signal is applied to the oscillation IDT 141 of the reference resonator 140, the oscillation IDT 141 vibrates at a resonant frequency and generates a SAW. Then, the generated SAW proceeds toward the reflective IDTs 142 and 143 that are respectively disposed at sides of the oscillation IDT 141 and is reflected and restored to the oscillation IDT 141. The restored SAW is then converted into an RF signal by the oscillation IDT 141.

The pressure resonator 130 and the temperature resonator 150 operate in the same mode as the reference resonator 140.

An antenna (not shown) is connected to each electrode 134 and 135, 144 and 145, and 154 and 155 of the reference resonator 140, the pressure resonator 130, and the temperature resonator 150, respectively, thereby applying an RF signal to each of the electrodes 134 and 135, 144 and 145, and 154 and 155 in a wireless manner and analyzing a resonant frequency of each of the reference resonator 140, the pressure resonator 130, and the temperature resonator 150 in which the SAW is restored. As such, each of the changes of an external pressure and temperature can be sensed.

First, a method of sensing a pressure change will now be described in detail.

As illustrated in FIG. 3, when the same pressure is applied to a top and the bottom surface of the membrane 121, an RF signal is applied to each of the reference resonator 140 and the pressure resonator 130, thereby measuring a resonant frequency of a SAW that is generated in each of the reference resonator 140 and the pressure resonator 130.

When the external pressure is increased, the membrane 121 is deformed, as illustrated in FIG. 4. As such, the characteristic of the SAW of the piezoelectric plate 120 of the membrane 121 is changed and the resonant frequency of the pressure resonator 130 is changed. The amount of change of the resonant frequency of the pressure resonator 130 is measured, thereby calculating the pressure applied to the membrane 121. Since the resonant frequency of the reference resonator 140 is not changed even though the external pressure changed, a difference between the resonant frequencies of the reference resonator 140 and the pressure resonator 130 is measured, and the pressure applied to the membrane 121 may be calculated from the difference.

In this way, in the SAW sensor 100, according to the current embodiment of the present invention, unlike the conventional SAW sensor of FIG. 1, the reference resonator 140, having a resonant frequency that is not changed in spite of a change of the external pressure, is additionally disposed outside the membrane 121, and thus, the accuracy for sensing pressure can be further improved as compared to the conventional SAW sensor of FIG. 1. Furthermore, in the conventional SAW sensor of FIG. 1, pressure is indirectly applied to the piezoelectric plate 3 through the diaphragm 1. On the other hand, in the SAW sensor 100, according to the current embodiment of the present invention, pressure is directly applied to the piezoelectric plate 120 and the membrane 121 is deformed. Thus, in the SAW sensor 100, the sensitivity for sensing pressure can be further improved, and a method of calculating pressure can be more simply and accurately performed as compared to the conventional SAW sensor of FIG. 1.

Next, a method of sensing a temperature change will be described.

As described above, the temperature resonator 150 is inclined with respect to the reference resonator 140 at a predetermined angle θ1 (see FIG. 2). Piezoelectric materials including quartz, which is used as material for the piezoelectric plate 120, have directivity. In other words, properties of matter of the piezoelectric materials, such as a thermal expansion coefficient, etc., are changed according to the crystalline direction of the piezoelectric plate 120. Thus, when the piezoelectric plate 120 contracts or expands due to a change of the external temperature, the amount of change of the resonant frequencies of the reference resonator 140 and the temperature resonator 150 is changed. The external temperature can be calculated based on the angle θ1 formed between the reference resonator 140 and the temperature resonator 150, the crystalline direction of the piezoelectric plate 120, and the amount of change of a resonant frequency of each of the reference resonator 140 and the temperature resonator 150. It is well-known in the art that temperature can be sensed from the amount of change of a resonant frequency of each the reference and temperature resonators 140 and 150 that are disposed such that the temperature resonator 150 is inclined with respect to the reference resonator 140, and thus, a detailed description thereof will be omitted.

The reference and temperature resonators 140 and 150 are printed on one of both surfaces of the piezoelectric plate 120 that faces the substrate 110, and the pressure resonator 130 is accommodated in the cavity 111 of the substrate 110, and the reference resonator 140 and the temperature resonator 150 are accommodated in the reference resonator groove 112 and the temperature resonator groove 113, respectively. Since each of the reference resonator 140 and the temperature resonator 150 is not exposed to the outside of the SAW sensor 100, the SAW sensor 100 can be used for a long time since the SAW sensor 100 is less likely to be contaminated or damaged due to external dust, chemical materials, etc.

As described above, the SAW sensor 100, according to the current embodiment of the present invention, can sense pressure and temperature simultaneously by using the temperature, reference, and pressure resonators 130, 140, and 150 that are printed on the piezoelectric plate 120. Since the reference resonator 140 and the temperature resonator 150 are disposed outside the membrane 121, the reference resonator 140 and the temperature resonator 150 are not affected by a change of an external pressure and thus can sense temperature accurately.

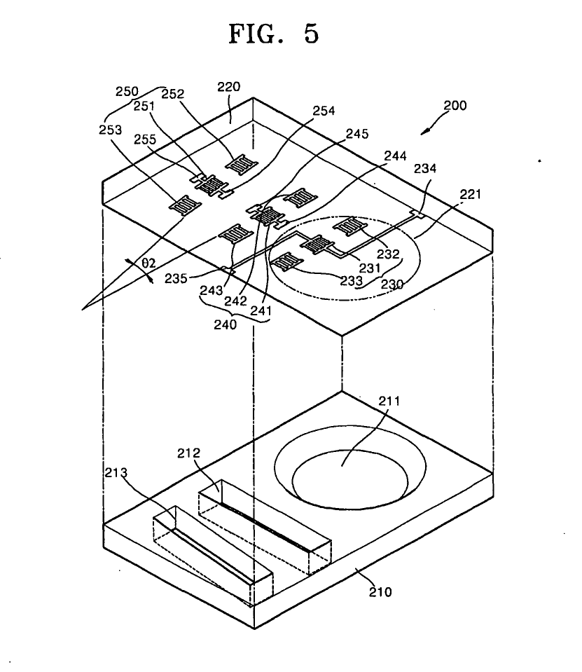

FIG. 5 is an exploded perspective view of a SAW sensor 200 according to another embodiment of the present invention.

Referring to FIG. 5, the SAW sensor 200, according to the current embodiment of the present invention, is characterized by provision of a substrate 210 having a different structure than that of the substrate 110 of FIG. 2. In addition, a pressure resonator 230, a reference resonator 240, and a temperature resonator 250 of the SAW sensor 200 of FIG. 5 are respectively the same as the pressure resonator 130, the reference resonator 140, and the temperature resonator 150 of the SAW sensor 100 of FIG. 2, but positions of electrodes 234, 235, 244, 245, 254, and 255, which are to be connected to an external circuit, as shown in FIG. 5, are different from those their respective ones of FIG. 2.

The SAW sensor 200 of FIG. 5 also comprises a substrate 210, a reference resonator 240, a pressure resonator 230, a temperature resonator 250, and a piezoelectric plate 220.

Also, a cavity 211 having a predetermined depth is formed in the substrate 210.

The piezoelectric plate 220 has piezoelectricity, and the reference resonator 240, the pressure resonator 230, and the temperature resonator 250 are printed on the piezoelectric plate 220.

The pressure, reference, and temperature resonators 230, 240, and 250 comprise an oscillation IDT 231, 241 and 251, and two reflective IDTs 232 and 233, 242 and 243, or 252 and 253, respectively, like the pressure, reference, and temperature resonators 130, 140, and 150 of FIG. 2. Unlike that the electrodes 144 and 145 of the reference resonator 140 and the electrodes 154 and 155 of the temperature resonator 150 are placed at edges of the piezoelectric plate 120, the electrodes 244 and 245 of the reference resonator 240 and the electrodes 254 and 255 of the temperature resonator 250 of FIG. 5 are placed near the oscillation IDTs 241 and 251, respectively. Also, the electrodes 234 and 235 of the pressure resonator 230 are placed at edges of the piezoelectric plate 220, like the electrodes 134 and 135 of the pressure resonator 130 of FIG. 2.

The pressure resonator 230 is disposed parallel to the reference resonator 240, and the temperature resonator 250 is disposed inclined with respect to the reference resonator 240 at a predetermined angle θ2.

Surface of the piezoelectric plate 220, on which the pressure resonator 230, the reference resonator 240, and the temperature resonator 250 are disposed, faces the substrate 210 so that the piezoelectric plate 220 and the substrate 210 can be adhered to each other. As such, the cavity 211 of the substrate 210 is covered by the piezoelectric plate 220. A portion of the piezoelectric plate 220 that corresponds to the cavity 311 is referred to as a membrane 221.

Like FIG. 2, the pressure resonator 230 is disposed on the membrane 221, and the reference resonator 240 and the temperature resonator 250 are disposed outside the membrane 221.

Unlike that the reference resonator groove 112 and the temperature resonator groove 113 are formed in the substrate 110 of FIG. 2, a reference resonator hole 212 and a temperature resonator hole 213 are formed in portions which correspond to the reference resonator 240 and the temperature resonator 250, respectively.

As a result, the pressure resonator 230 is accommodated in the cavity 211 and does not contact the substrate 210, and the reference resonator 240 and the temperature resonator 250 are accommodated in the reference resonator hole 212 and the temperature resonator hole 213, respectively, and do not contact the substrate 210.

In the SAW sensor 200 of FIG. 5, wire bonding can be performed on the electrodes 244, 245, 254, and 255 of the reference resonator 240 and the temperature resonator 250 through the reference resonator hole 212 and the temperature resonator hole 213. Thus, the electrodes 244, 245, 254, and 255 of the reference resonator 240 and the temperature resonator 250 can be easily connected to the external circuit.

The function of the SAW sensor 200 of FIG. 5 and a method of sensing pressure and temperature by using the SAW sensor 200 are the same as those of the SAW sensor 100 of FIG. 2.

As described above, exemplary embodiments of a SAW sensor according to the present invention have been described. However, the SAW sensor according to the present invention is not limited to the above-described embodiments, and various types of SAW sensors may be specified without departing from the spirit and scope of the present invention by modification or combination of the embodiments.

For example, as described previously, the pressure, reference, and temperature resonators 130, 140, and 150 or 230, 240, and 250 are installed on one of the surfaces of the piezoelectric plate 120 or 220 that faces the substrate 110 or 210, respectively. However, the pressure, reference, and temperature resonators 130, 140, and 150 or 230, 240, and 250 may be installed on surface opposite to the surfaces that face the substrate 110 or 210.

In addition, as described previously, the SAW sensor 100 of FIG. 2 or the SAW sensor 200 of FIG. 5 comprises the temperature resonator 150 or 250, respectively. However, the SAW sensor 100 or 200 may comprise only a pressure resonator and a reference resonator, not the temperature resonator 150 or 250.

Furthermore, as described previously, the reference resonator 140 or 240, the pressure resonator 130 or 230, and the temperature resonator 150 or 250 comprise the oscillation IDT 131, 141, and 151 or 231, 241, and 251, and the reflective IDTs 132 and 133, 142 and 143, 152 and 153, 232 and 233, 242 and 243, or 252 and 253, respectively. However, a SAW sensor using SAW resonators having a different structure than those of the SAW sensor 100 and 200 may be constituted.

While the present invention has been particularly shown and described with reference to exemplary embodiments thereof, it will be understood by one of ordinary skill in the art that various changes in form and details may be made therein without departing from the spirit and scope of the present invention as defined by the following claims.

1. A surface acoustic wave (SAW) sensor sensing pressure, temperature, etc., by using a SAW, the SAW sensor comprising:
a substrate having one of its surfaces formed with a cavity having a predetermined depth;
a piezoelectric plate which has piezoelectricity, so as to make a SAW, and which is adhered to the surface in which the cavity is formed, so as to cover the cavity of the substrate;
a pressure resonator which is installed to a portion of the piezoelectric plate that corresponds to the cavity groove, and which generates a SAW due to a radio frequency (RF) signal applied thereto; and
a reference resonator which is installed to the piezoelectric plate to be outside the portion corresponding to the cavity and be parallel to the pressure resonator, and which generates a SAW due to the RF signal applied thereto.

2. The SAW sensor of claim 1, wherein the reference resonator and the pressure resonator are installed on the surface of the piezoelectric plate which faces the substrate, and a reference resonator groove in which the reference resonator is accommodated is formed in the substrate.

3. The SAW sensor of claim 1, wherein the reference resonator and the pressure resonator are installed on the surface of the piezoelectric plate which faces the substrate, and a portion of the substrate corresponding to the reference resonator is perforated.

4. The SAW sensor of claim 1, wherein the reference resonator and the pressure resonator each comprise an oscillation inter-digital transducer (IDT) which generates a SAW due to an externally applied RF signal, and a plurality of reflective IDTs, one or more of which is disposed respectively at sides of the oscillation IDT and which reflect the SAW generated in the oscillation IDT.

5. The SAW sensor of claim 1, further comprising a temperature resonator which is installed on the piezoelectric plate, is disposed inclined with respect to the reference resonator, and which generates a SAW due to an RF signal applied thereto.

6. The SAW sensor of claim 5, wherein the reference resonator, the is pressure resonator, and the temperature resonator are installed on a surface of the piezoelectric plate which faces the substrate, and a reference resonator groove, in which the reference resonator is accommodated, and a temperature resonator groove, in which the temperature resonator is accommodated, are formed in the substrate.

7. The SAW sensor of claim 5, wherein the reference resonator, the pressure resonator and the temperature resonator are installed on the surface of the piezoelectric plate which faces the substrate, and each of portions of the substrate corresponding to the reference resonator and the temperature resonator is perforated.

8. The SAW sensor of claim 5, wherein the reference resonator, the pressure resonator, and the temperature resonator each comprise an oscillation inter-digital transducer (IDT) which generates a SAW due to an externally applied RF signal, and a plurality of reflective IDTs, one or more of which is disposed respectively at sides of the oscillation IDT and which reflect the SAW generated in the oscillation IDT.

9. The SAW sensor of claim 2, wherein the reference resonator and the pressure resonator each comprise an oscillation inter-digital transducer (IDT) which generates a SAW due to an externally applied RF signal, and a plurality of reflective IDTs, one or more of which is disposed respectively at sides of the oscillation IDT and which reflect the SAW generated in the oscillation IDT.

10. The SAW sensor of claim 3, wherein the reference resonator and the pressure resonator each comprise an oscillation inter-digital transducer (IDT) which generates a SAW due to an externally applied RF signal, and a plurality of reflective IDTs, is one or more of which is disposed respectively at sides of the oscillation IDT and which reflect the SAW generated in the oscillation IDT.

11. The SAW sensor of claim 6, wherein the reference resonator, the pressure resonator, and the temperature resonator each comprise an oscillation inter-digital transducer (IDT) which generates a SAW due to an externally applied RF signal, and a plurality of reflective IDTs, one or more of which is disposed respectively at sides of the oscillation IDT and which reflect the SAW generated in the oscillation IDT.
